(19) United States
(12) Patent Application Publication
(10) Pub. No.: US 2026/0055900 A1
(43) Pub. Date: Feb. 26, 2026

(54) COOKING APPLIANCE WITH POWER SHARING

(71) Applicant: Midea Group Co., Ltd., Foshan (CN)

(72) Inventors: Felix Conde Zelocuatecatl, Louisville, KY (US); Antonio Lopez Juarez, Louisville, KY (US)

(73) Assignee: Midea Group Co., Ltd., Foshan (CN)

(21) Appl. No.: 18/811,192

(22) Filed: Aug. 21, 2024

(51) Int. Cl. F24C 7/08; H02J 7/00

(52) U.S. Cl. CPC F24C 7/087; H02J 7/0047; H02J 7/0063

(57) ABSTRACT

A cooking appliance utilizes a rechargeable battery to selectively power one or more electric cooking elements of the cooking appliance instead of using an external power source such as a residential power circuit whenever the combined power demand of the active electric cooking elements exceeds the available power from the external power source, e.g., by causing an electric cooking element to be powered by the rechargeable battery instead of the external power source based at least in part on an activation state of another electric cooking element.

### BACKGROUND

Cooking appliances such as cooktops and ranges generally utilize gas and/or electrically powered cooking elements to generate heat for cooking food. Gas cooking elements generate heat by burning gas supplied by a building's gas supply. Some electric cooking elements such as calrods generate heat by running electric current through a resistive material, while others such as induction cooking elements generate heat by wirelessly transferring electrical energy to an electrically conductive pot or pan.

One drawback of electric cooking elements is that the amount of power they require in order to generate comparable heat outputs to gas cooking elements can create a conflict with the practical limits of the circuits that provide power to the cooking appliances utilizing such cooking elements. Some residential ranges, for example, may include four or five cooktop cooking elements and one or two oven cooking elements, and were all of these cooking elements activated at the same time, the current draw would easily exceed the maximum allowable current draw in a typical residential electrical circuit. For this reason, despite the fact that the majority of the electrical circuits in US households operate at 120 VAC, many electric ranges require the use of a dedicated 240 VAC electrical circuit.

For various reasons, efforts have been made to migrate away from gas cooking appliances to electric cooking appliances, and in some instances, to replace existing gas cooking appliances with comparable electric cooking appliances. Rewiring an existing structure to add a 240 VAC electrical circuit, however, can be expensive, and can even be cost prohibitive in some circumstances.

Therefore, a significant need continues to exist in the art for a manner of powering a cooking appliance with electric cooking elements.

### SUMMARY

The herein-described embodiments address these and other problems associated with the art by providing a cooking appliance that incorporates a rechargeable battery and that selectively powers one or more electric cooking elements using the rechargeable battery instead of an external power source based at least in part on an activation state of another electric cooking element in the cooking appliance.

Therefore, consistent with one aspect of the invention, a cooking appliance may include first and second electric cooking elements, first and second user controls respectively configured to operate the first and second electric cooking elements, a line input configured to receive a power signal from an external power source, a rechargeable battery, and a control circuit coupled to the first and second electric cooking elements and the first and second user controls. The control circuit is configured to, when the first electric cooking element is activated by the first user control, cause the first electric cooking element to be powered by the line input, and when the second electric cooking element is activated by the second user control, cause the second electric cooking element to be powered by the rechargeable battery instead of by the line input based upon whether the first electric cooking element is currently activated by the first user control.

In some embodiments, the first electric cooking element is configured to be powered only using the line input, and the second electric cooking element is switchable between being powered only using the line input and being powered only using the rechargeable battery. Also, in some embodiments, the control circuit includes first and second relays respectively coupling the second electric cooking element to the line input and the rechargeable battery, and the control circuit is configured to cause the second electric cooking element to be powered by the rechargeable battery instead of by the line input by activating the second relay while the first relay is deactivated.

In addition, some embodiments may further include a third electric cooking element and a third user control configured to operate the third electric cooking element, and the control circuit is further configured to cause the second electric cooking element to be powered by the rechargeable battery instead of by the line input further based upon whether the third electric cooking element is currently activated by the third user control. Further, in some embodiments, the first and second electric cooking elements are cooktop cooking elements and the third electric cooking element is an oven cooking element.

In some embodiments, the control circuit is configured to cause each of the first, second, and third cooking elements to be powered by the line input when only one of the first, second, and third cooking elements is activated by the respective first, second, and third user control, cause the first cooking element to be powered by the line input and cause the second cooking element to be powered by the rechargeable battery when only the first and second cooking elements are activated by the respective first and second user controls, to cause the first cooking element to be powered by the line input and cause the third cooking element to be powered by the rechargeable battery when only the first and third cooking elements are activated by the respective first and third user controls, and to cause the first cooking element to be powered by the line input and cause the second and third cooking elements to be powered by the rechargeable battery when all of the first, second, and third cooking elements are activated by the respective first, second, and third user controls.

In addition, in some embodiments, the control circuit is further configured to charge the rechargeable battery when the first and second electric cooking elements are deactivated by the respective first and second user controls. In some embodiments, the control circuit is further configured to detect a power loss and cause at least one of the first and second cooking elements to be powered by the rechargeable battery in response thereto. In addition, in some embodiments, the control circuit is further configured to determine a power loss threshold criterion based on a charge state of the rechargeable battery and to notify a user of limited power in response to detecting the power loss. Moreover, in some embodiments, the control circuit is further configured to supply limited power to the first and second cooking elements based on the determined power loss threshold criterion.

In some embodiments, the first and second electric cooking elements are among a plurality of electric cooking elements, and the control circuit is further configured to determine a power demand based upon an activation state of each of the plurality of cooking elements. Moreover, in some embodiments, the control circuit is further configured to cause each activated electric cooking element among the plurality of electric cooking elements to be powered by the line input if the power demand meets a line threshold criterion.

In some embodiments, the control circuit is further configured to determine a combined threshold criterion based on a charge state of the rechargeable battery. In addition, in some embodiments, the control circuit is further configured to notify a user of limited operation if the power demand meets the combined threshold criterion. In some embodiments, the control circuit is further configured to disable one or more of the plurality of electric cooking elements if the power demand meets the combined threshold criterion.

Moreover, in some embodiments, the first and second electric cooking elements are among a plurality of electric cooking elements, and the control circuit is further configured to monitor a charge state of the rechargeable battery and to selectively disable one or more of the plurality of electric cooking elements based on the monitored charge state. Also, in some embodiments, the control circuit is further configured to notify a user that the one or more of the plurality of electric cooking elements are being disabled.

In some embodiments, the first and second electric cooking elements are among a plurality of electric cooking elements, and the control circuit is further configured to monitor a weather forecast and to disable use of the rechargeable battery to power any of the plurality of electric cooking elements in advance of a predicted power loss based on the monitored weather forecast. In addition, in some embodiments, the control circuit is further configured to reject an attempt to concurrently use multiple electric cooking elements of the plurality of electric cooking elements in advance of the predicted power loss.

Consistent with another aspect of the invention, a method is provided for operating a cooking appliance of a type including first and second electric cooking elements, first and second user controls respectively configured to operate the first and second electric cooking elements, a line input configured to receive a power signal from an external power source, and a rechargeable battery. The method includes detecting user interaction with the second user control to activate the second electric cooking element, in response detecting the user interaction, selecting between powering the second electric cooking element using the line input or powering the second electric cooking element using the rechargeable battery based upon whether the first electric cooking element is currently activated by the first user control, and powering the second electric cooking element using the selected one of the line input and the rechargeable battery.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a perspective view of a cooking appliance consistent with some embodiments of the invention.

FIG. 2 is a block diagram of another example cooking appliance consistent with some embodiments of the invention.

FIG. 3 is a flowchart illustrating an example operational sequence for operating the cooking appliance of FIG. 2.

FIG. 4 is a block diagram of another example cooking appliance consistent with some embodiments of the invention.

FIG. 5 is a chart of an example mapping of power sources to cooking elements for the cooking appliance of FIG. 4.

FIG. 6 is a flowchart illustrating an example operational sequence for operating the cooking appliance of FIG. 4.

FIG. 7 is a block diagram of one implementation of the power sharing device referenced in FIG. 4.

FIG. 8 is a flowchart illustrating an example operational sequence for monitoring battery level in the aforementioned cooking appliances.

FIG. 9 is a flowchart illustrating an example operational sequence for monitoring weather in the aforementioned cooking appliances.

### DETAILED DESCRIPTION

In the embodiments discussed hereinafter, a cooking appliance may utilize a rechargeable battery to selectively power one or more cooking elements of the cooking appliance whenever the combined power demand of the active electric cooking elements exceeds the available power from an external power source such as a residential power circuit. In particular, in some embodiments of the invention, an electric cooking element may be powered by a rechargeable battery instead of an external power source based at least in part on an activation state of another electric cooking element in the cooking appliance.

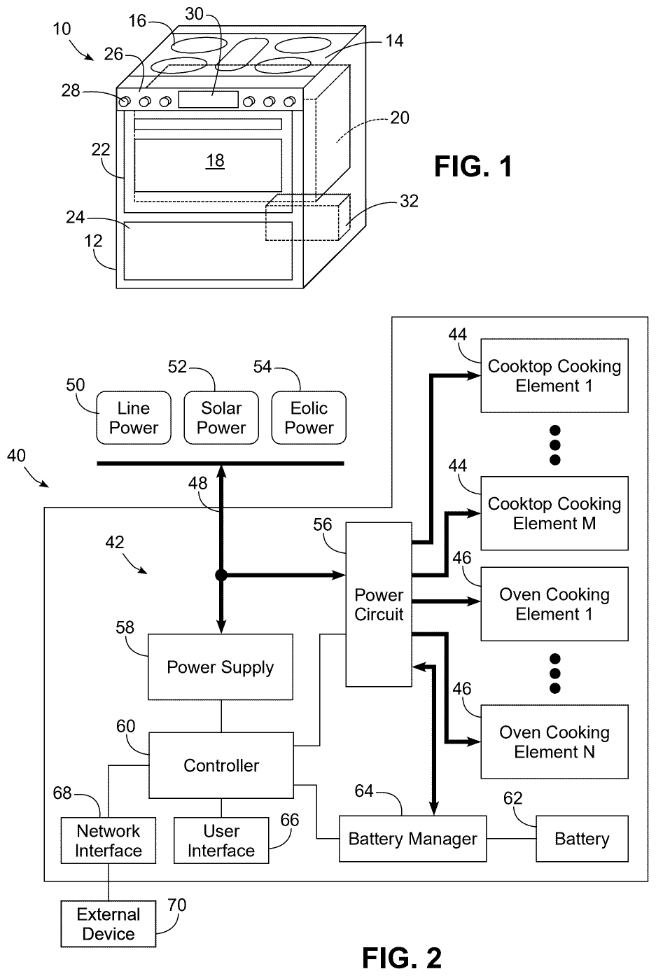

Turning now to the drawings, wherein like numbers denote like parts throughout the several views, FIG. 1 illustrates an example cooking appliance 10 in which the various technologies and techniques described herein may be implemented. Cooking appliance 10 is a residential-type range, and as such includes a housing 12, a stovetop or cooktop 14 including a plurality of cooking elements or burners 16, and an oven 18 defining an oven or cooking cavity 20 accessed via an oven door 22. Cooking appliance 10 may also include a storage drawer 24 in some embodiments, or in other embodiments, may include a second oven. Various cooking elements (not shown in FIG. 1) may also be incorporated into cooking appliance 10 for cooking food in oven 18, e.g., one or more electric or gas cooking elements.

Cooking appliance 10 may also include various user controls or user interface devices, including, for example, a control panel 26 incorporating a plurality of rotary burner controls 28 and a user interface or display 30 for providing visual feedback as to the activation state of the cooking appliance. It will be appreciated that cooking appliance 10 may include various types of user controls in other embodiments, including various combinations of switches, buttons, knobs, and/or sliders, typically disposed at the rear or front (or both) of the cooking appliance. Further, in some embodiments, one or more touch screens may be employed for interaction with a user. As such, in some embodiments, display 30 may be touch sensitive to receive user input in addition to displaying status information and/or otherwise interacting with a user. In still other embodiments, cooking appliance 10 may be controllable remotely, e.g., via a smartphone, tablet, personal digital assistant, or other networked computing device, e.g., using a web interface or a dedicated app. In some embodiments, both the cooktop burners and the oven may be controlled by the same electronic control system, while in other embodiments, different control systems may be used for separate control of each system.

Displays 30 may also vary in different embodiments, and may include individual indicators, segmented alphanumeric displays, and/or dot matrix displays, and may be based on various types of display technologies, including LEDs, vacuum fluorescent displays, incandescent lights, etc. Further, in some embodiments, audio feedback may be provided to a user via one or more speakers, and in some embodiments, user input may be received via a spoken or gesture-based interface.

Cooking appliance 10 also includes one or more rechargeable batteries 32, which as will be discussed in greater detail below, may be used to selectively power one or more cooking elements of the cooking appliance.

As noted above, cooking appliance 10 of FIG. 1 is a range, which combines both a stovetop and one or more ovens, and which in some embodiments may be a standalone or drop-in type of range. In other embodiments, however, cooking appliance 10 may be another type of cooking appliance, e.g., a cooktop, stovetop or hob lacking an integrated oven, or a wall or counter oven lacking cooktop burners. In general, a cooking appliance consistent with the invention may be considered to include any residential-type appliance including a housing and one or more cooking elements disposed therein and configured to generate energy for cooking food.

In turn, a cooking element may be considered to include practically any type of energy-producing element used in residential applications in connection with cooking food, e.g., employing various cooking technologies such as electric, gas, light, microwaves, induction, convection, radiation, etc. In the case of an oven, for example, one or more cooking elements therein may be gas, electric (e.g., calrod), light, or microwave cooking elements in some embodiments, while in the case of a cooktop, one or more cooking elements therein may be gas, resistive electric (e.g., calrod), or induction electric cooking elements in some embodiments. Further, it will be appreciated that any number of cooking elements may be provided in a cooking appliance (including multiple cooking elements for performing different types of cooking cycles such as baking or broiling), and that multiple types of cooking elements may be combined in some embodiments, e.g., combinations of microwave and light cooking elements in some oven embodiments.

A cooking appliance consistent with the invention also generally includes one or more control circuits configured to control the cooking elements and otherwise perform cooking operations at the direction of a user. FIG. 2, for example, illustrates a cooking appliance 40 capable of implementing power sharing consistent with the invention, and which includes a control circuit or electronic control system 42 capable of powering a plurality of electric cooking elements, e.g., 1 . . . M cooktop cooking elements 44 and 1 . . . N oven cooking elements 46. Each cooking element 44, 46, for example, may be implemented as a resistive cooking element such as a calrod, an induction cooking element, or any other suitable electrically-powered cooking element. Electrical power is supplied through a line input 48, e.g., to connect to an external power source, e.g., line power 50, such as a 120 VAC residential power circuit. It will also be appreciated that cooking appliance 40 may also be powered by other external power sources, e.g., solar power 52, eolic (wind) power 54, or any other suitable renewable or non-renewable source of electrical power. In addition, while a 120 VAC residential power circuit is used for line power 50 in the illustrated embodiments, other types of power circuits, e.g., 208 or 240 VAC power circuits, may be used in other embodiments. An advantage of utilizing a 120 VAC residential power circuit, for example, is that comparable performance to a gas cooking appliance, which would otherwise require the use of a 240 VAC power circuit to power electric cooking elements, may be achieved in some embodiments, thereby enabling the cooking appliance to be used in applications where use of a 240 VAC power circuit is not practical.

Line power (represented in FIG. 2 by thicker black lines) is provided to a power circuit 56 to distribute the line power to some or all of cooking elements 44, 46, as well as to a power supply 58 to generate lower power DC power signals suitable for powering various electronic devices in cooking appliance 40, e.g., a controller 60 that controls the overall operation of cooking appliance 40, including the operation of cooking elements 44, 46.

Cooking appliance 40 additionally includes one or more rechargeable batteries, represented collectively by battery 62, to store electrical power for the purpose of selectively powering one or more of cooking elements 44, 46, among other purposes as will be discussed in greater detail below. Discharging and recharging of battery 62 is managed by a battery manager circuit 64, which is controlled in part by controller 60. Battery manager circuit 64 includes suitable conversion circuitry to convert from line power received from power circuit 56 to a DC power signal suitable for charging battery 62, as well as to convert from a DC power signal output by battery 62 to line power suitable for distribution by power circuit 56 to one or more of cooking elements 44, 46. Battery manager circuit 64 additionally manages recharging of battery 62, as well as monitoring a charge state of the battery, e.g., to determine whether the battery is full or empty, or in some embodiments, a relative amount of charge left in the battery (e.g., based on percentage of full, output voltage, etc.).

Controller 60 is additionally coupled to a user interface 66, which includes one or more user controls suitable for activating associated cooking elements 44, 46, as well as performing other operations that will be apparent to those of ordinary skill in the art having the benefit of the instant disclosure. Moreover, in some embodiments, controller 60 may also be coupled to a network interface 68, e.g., a wired and/or wireless network interface, to couple with one or more external devices 70, e.g., a computer, a mobile device, a cloud service, etc., thereby enabling remote access to, and in some instances, remote control of, cooking appliance 40.

Controller 60, in the illustrated embodiment, is configured to control power circuit 56 to selectively power each of cooking elements 44, 46, including to activate/deactivate each cooking element 44, 46, as well as control a relative output level of each activated cooking element, generally based upon an activation state defined by an associated user control from user interface 66 (e.g., on/off, low/medium/high, and/or a percentage of a maximum output level, or any other state that is reflective of whether the cooking element is active as well as the relative output level of the cooking element. It will be appreciated that in some embodiments, control of the output level may be based on varying the instantaneous power supplied to a cooking element (e.g., by varying the voltage), while in other embodiments, control of the output level may be based on varying a duty cycle of the power supplied to a cooking element (e.g., such that the cooking element is repeatedly cycled between on and off states at a rate that lowers the overall output level over time).

In the illustrated embodiment, controller 60 controls power circuit 56 to selectively power each active cooking element 44, 46 using only one of line power from line input 48 and power from battery 62. Put another way, rather than combining the outputs of line input 48 and battery 62 and distributing the collective power to the active cooking elements, controller 60 and power circuit 56 are configured to couple individual active cooking elements to either line input 48 or battery 62 such that each individual active cooking element is powered by a single source of power. Moreover, as will be discussed in greater detail below, in the illustrated embodiment whether a particular cooking element is powered by line input 48 or battery 62 may be based, at least in part, on the activation state of one or more other cooking elements, e.g., whether another cooking element is or is not currently activated. Other manners of distributing power among the active cooking elements may be used in other embodiments; however, so the invention is not limited to the specific manner of distributing power utilized in cooking appliance 40.

In some embodiments, for example, power circuit 56 may include, for each cooking element 44, 46, a line power relay configured to couple the cooking element to line input 48, and a battery relay configured to couple the cooking element to battery 62 via battery manager circuit 64. As such, controller 60 may couple a cooking element to one of line input 48 and battery 62 by activating the corresponding relay.

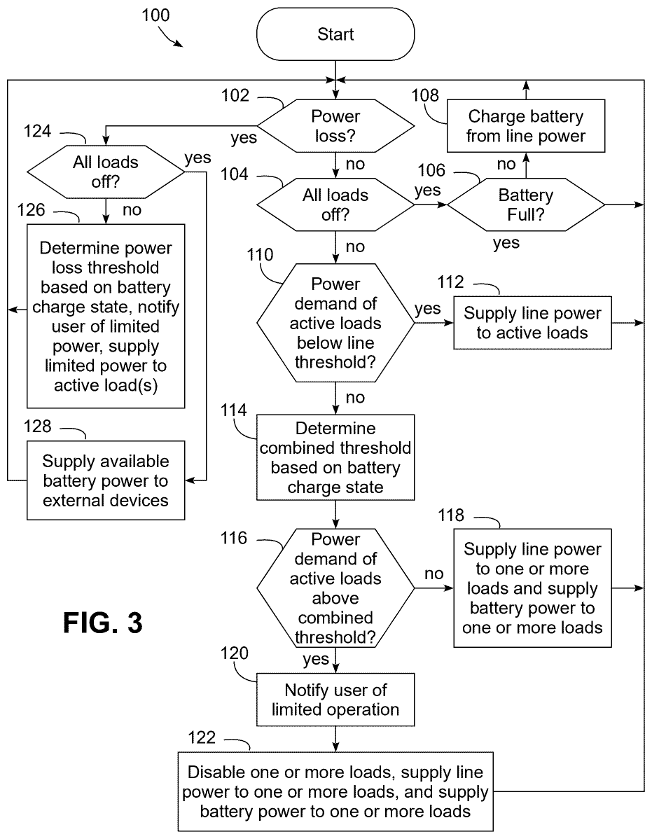

FIG. 3, for example, illustrates an example operational sequence 100, executable by controller 60, to control activation of cooking elements 44, 46. Sequence 100 begins in block 102 by determining if there is a power loss, i.e., if no power is supplied by line input 48. If not, control passes to block 104 to determine if all loads (i.e., cooking elements) are currently off. If so, control passes to block 106 to determine if the battery is full, and if so, return to block 102. If not, block 106 passes control to block 108 to initiate charging of the battery from line power.

If any cooking element is active, block 104 passes control to block 110 to determine if the power demand of the active loads meets a line threshold criterion. In some embodiments, for example, the line threshold criterion is based upon whether the combined power demand of the active loads is below a line threshold. The line threshold, for example, may represent a maximum current draw for line power, e.g., based upon an amperage rating of a residential power circuit, such as 15A or 20A. Moreover, each active load (cooking element) may be assigned a single power demand, e.g., based upon its power draw at its maximum output level, or a variable power demand based upon the current output level of the cooking element (in the case that a variable power signal is supplied to the cooking element).

If the line threshold criterion is met, block 110 passes control to block 112 to cause each of the active loads (cooking elements) to be powered by line power from the line input. If not, however, control passes to block 114 to determine a combined threshold criterion based in part on the current charge state of the battery. The combined threshold criterion is based upon whether the combined power demand of the active loads (which may be determined in the various manners discussed above in connection with block 110) is capable of collectively being supplied by the line input and the battery, so the combined threshold criterion may be used to determine whether or not all active loads can be adequately powered by the available line input power and battery power. If so, control passes to block 118 to supply line power to one or more loads and supply battery power to one or more loads. For example, if it is determined that line power is capable of supporting one active cooking element, but line power combined with battery power is capable of powering three active cooking elements, controller 60 may cause one active cooking element to be powered by line power and two active cooking elements to be powered by battery power.

Returning to block 116, if the power demand of the active loads is above the combined threshold (i.e., the combined threshold criterion is met), control may pass to block 120 to notify a user of limited operation (e.g., a need to disable one or more loads) via user interface 66, such as an audio and/or visual warning, via a message to an external device, or in other suitable manners. Control then passes to block 122 to block 122 to disable one or more loads, while still supplying available line and power to each of one or more active loads. Thus, for example, if it is determined that when there are three active cooking elements, line power combined with battery power is capable of powering only two active cooking elements, controller 60 may cause one active cooking element to be powered by line power, one active cooking element to be powered by battery power, and one active cooking element to be disabled. In some embodiments, it may also be desirable to limit the maximum output level of one or more active cooking elements in order to ensure sufficient available power at the current charge state of the battery.

Returning now to block 102, in the event of a power loss, control may pass to block 124 to determine whether all loads are currently off. If not, control passes to block 126 to determine a power loss threshold based on the charge state of the battery. The power loss threshold criterion is based upon the amount of power capable of being provided by the battery based upon its current charge state, so the power loss threshold criterion may be used to determine which and/or how many active loads (cooking elements) may be powered by the battery at its current charge state, and in some instances, a maximum output level that may be permitted for such active loads. In addition, a user may be notified of the limited available power, e.g., in the various manners discussed above in connection with block 120.

Returning to block 124 if all loads are off, control passes to block 128 to optionally supply available battery power to power one or more external devices, e.g., by supplying power back through line input 48 to power other devices coupled to the power circuit, to supply power back to the grid, or to supply power to one or more electrical outlets provided on the cooking appliance itself. In other embodiments, supplying power to other devices may be omitted.

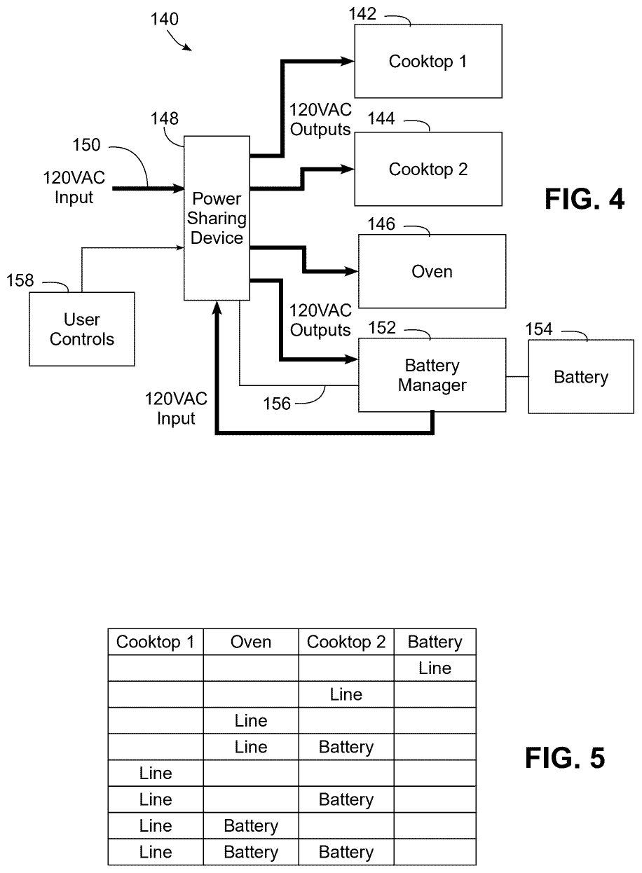

Now turning to FIGS. 4-7, another example cooking appliance 140 capable of implementing power sharing consistent with the invention is illustrated. As shown in FIG. 4, for example, cooking appliance 140 may include two cooktop electric cooking elements 142, 144 (also referred to herein as the cooktop 1 and cooktop 2 cooking elements) and one oven electric cooking element 146. In some embodiments, cooking elements 142, 144 may be implemented as induction cooking elements, while cooking element 146 may be implemented as a resistive cooking element, although the invention is not so limited.

A power sharing device 148, which in some embodiments may include a controller or other type of control circuit suitable for controlling the operation of cooking appliance 140, is configured with a plurality of power outputs (e.g., 120 VAC power outputs, and represented by thicker black lines in FIG. 4) to route power to each of cooking elements 142, 144, 146. To implement power sharing, power sharing device 148 also includes a plurality of power inputs (also represented by thicker black lines in FIG. 4). One power input is coupled to an external power source such as a 15A or 20A 120 VAC residential power circuit, which is received by power sharing device 148 through a line input 150. Another power input is coupled to a battery manager circuit 152 that manages the charging and discharging of one or more rechargeable batteries (represented by battery 154). In order to recharge battery 154, an additional power output (e.g., a 120 VAC output) is also supplied by power sharing device 148 to battery manager circuit 152. Similar to battery manager circuit 64 of FIG. 2, battery manager circuit 152 may include suitable conversion circuitry to convert from line power received from power sharing device 148 to a DC power signal suitable for charging battery 154, as well as to convert from a DC power signal output by battery 154 to line power suitable for distribution by power sharing device 148 to one or more of cooking elements 142, 144, 146. Battery manager circuit 152 additionally manages recharging of battery 154, as well as monitoring a charge state of the battery, e.g., to determine whether the battery is full or empty, or in some embodiments, a relative amount of charge left in the battery (e.g., based on percentage of full, output voltage, etc.). Power sharing device 148 and battery manager circuit 152 are also in communication with one another, e.g., via lines 156, thereby enabling communication between the two circuits.

FIG. 5 illustrates a chart describing a mapping of power sources to cooking elements implemented by power sharing device 148 for use in distributing power to cooking elements 142, 144, 146 and battery manager circuit 152/battery 154 based on the activation states of the various user controls 158. In this chart, text in a particular cell indicates that the associated user control corresponding to the cooking element represented by the column is set to an on or active state, while a blank cell indicates that the associated user control is set to an off or inactive state.

It may be seen from this chart that cooktop 1 cooking element 142 is always supplied by line power when activated, while each of cooktop 2 and oven cooking elements 144, 146 is supplied by line power when activated alone. However, when two cooking elements are activated simultaneously, at least one of the cooking elements is supplied with battery power, with each of cooktop 2 cooking element 144 and oven cooking element 146 supplied by battery power if cooktop 1 cooking element 142 (which is supplied with line power) is also active, and with oven cooking element 146 supplied by line power and cooktop 2 cooking element 144 supplied with battery power if cooking elements 144, 146 are both active. If all three cooking elements are active at the same time, cooktop 1 cooking element 142 is supplied with line power while each of cooktop 2 cooking element 144 and oven cooking element 146 is supplied with battery power. Finally, when all three cooking elements are deactivated, line power is supplied to battery manager circuit 152/battery 154 to recharge the battery as necessary.

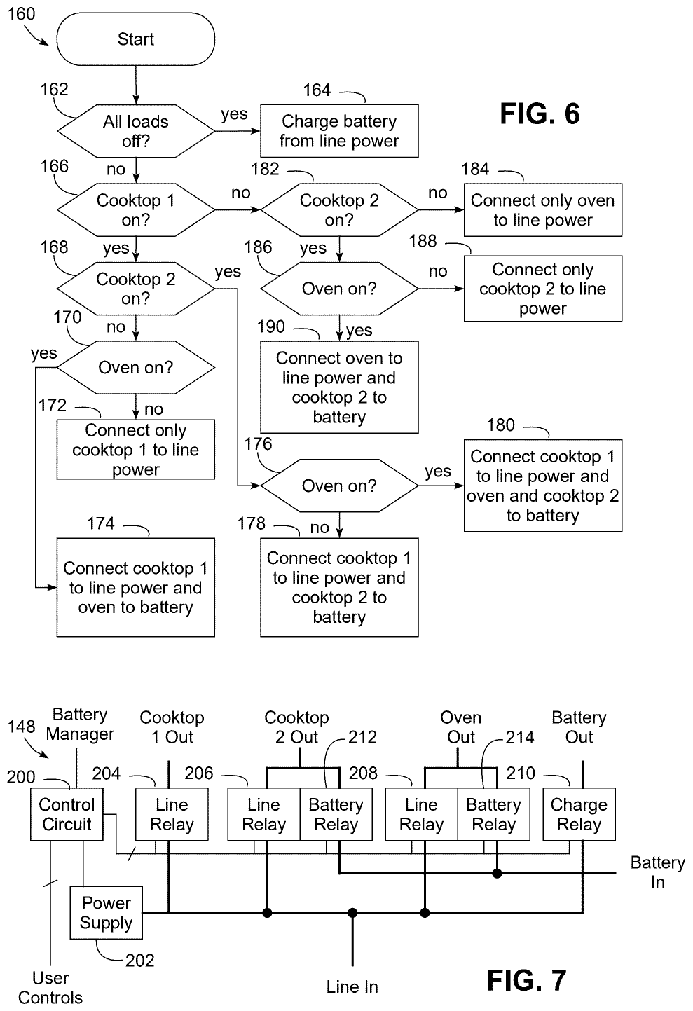

An operational sequence suitable for execution by power sharing device 148 to implement the chart of FIG. 5 is illustrated at 160 in FIG. 6. As illustrated in block 162, when all loads (cooking elements) are off or inactive, control passes to block 164 to charge the battery from line power. Otherwise, block 162 passes control to block 166 to determine if the cooktop 1 cooking element 142 is on or active. If so, control passes to block 168 to determine if the cooktop 2 cooking element 144 is also on or active, and if not, control passes to block 170 to determine if the oven cooking element 146 is also on or active. If not, block 170 passes control to block 172 to only connect the cooktop 1 cooking element 142 to line power. Otherwise, block 170 passes control to block 174 to connect the cooktop 1 cooking element 142 to line power and connect the oven cooking element 146 to battery power.

Returning to block 168, if the cooktop 2 cooking element 144 is also on or active, control passes to block 176 to determine if the oven cooking element 146 is also on or active. If not, block 176 passes control to block 178 to connect the cooktop 1 cooking element 142 to line power and connect the cooktop 2 cooking element 144 to battery power. Otherwise, block 176 passes control to block 180 to connect the cooktop 1 cooking element 142 to line power and connect both of the cooktop 2 cooking element 144 and oven cooking element 146 to battery power.

Returning to block 166, if the cooktop 1 cooking element 142 is off or inactive, control passes to block 182 to determine if the cooktop 2 cooking element 144 is on or active. If not, block 182 passes control to block 184 to connect only the oven cooking element 146 to line power. Otherwise, block 182 passes control to block 186 to determine if the oven cooking element 146 is also on or active. If not, block 186 passes control to block 188 to connect only the cooktop 2 cooking element 144 to line power. If, however, the oven cooking element 146 is also on or active, block 186 passes control to block 190 to connect the oven cooking element 146 to line power and connect the cooktop 2 cooking element 144 to battery power.

FIG. 7 illustrates one example implementation of power sharing device 148 consistent with some embodiments of the invention. In this embodiment, a control circuit 200 manages the supply of power to the different cooking elements 142, 144, 146 and to battery manager circuit 152/battery 154 responsive to the activation states of various user controls (e.g., knobs) associated with the cooking elements 142, 144, 146. Control circuit 200 is supplied with DC power by a power supply 202 that is coupled to receive line power (e.g., 120 VAC line power) from line input 150. The line input is also coupled to a plurality of line relays 204, 206, 208 that respectively supply line power to cooktop 1 cooking element 142, cooktop 2 cooking element 144 and oven cooking element 146, as well as a charge relay 210 that is coupled to battery manager circuit 152/battery 154 to supply line power for recharging the battery. Battery power (e.g., 120 VAC battery power generated from battery 154 by battery manager circuit 152) is supplied to a pair of battery relays 212, 214 that are respectively coupled to cooktop 2 cooking element 144 and oven cooking element 146, and a control signal is supplied from control circuit 200 to each of relays 204-214 to enable control circuit 200 to selectively activate and deactivate each relay.

It will be appreciated that in the illustrated embodiment, in which cooktop 1 cooking element 142 is always powered by line power, a separate battery relay can be omitted. In other embodiments, however, a battery relay may also be included for cooking element 142 if desired (e.g., for powering the cooking element with battery power when a power loss occurs). It will also be appreciated that power sharing device 148 generally provides a relatively simple and cost effective solution for implementing power sharing that is based on the activation states of different cooking elements and selectively activation of individual relays, rather than attempting to manage line power and battery power in a combined manner and/or based on actual monitored power consumption.

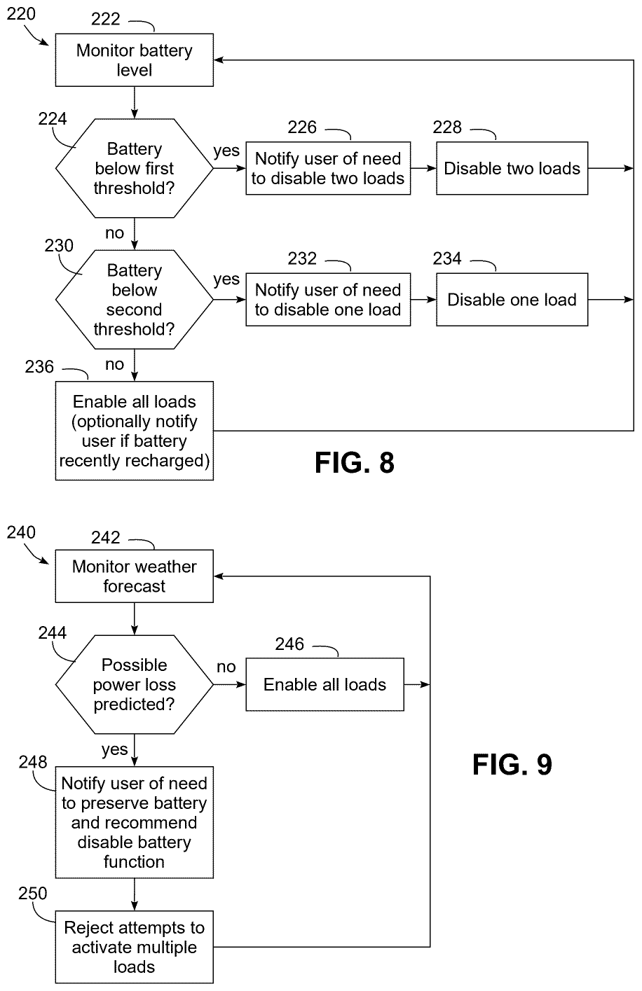

Now turning to FIG. 8, an example implementation of an operational sequence for monitoring battery level in a cooking appliance such as described above in connection with FIGS. 1, 2, and 4 above is illustrated at 220. Operational sequence 220 may be executed by a suitable control circuit or controller of a cooking appliance, e.g., controller 60 or control circuit 200, and may rely on battery charge status information provided by a battery manager circuit such as battery manager circuit 64 or 152. In some embodiments, for example, operational sequence 220 may monitor a charge state of a rechargeable battery and selectively disable one or more cooking elements based on the monitored charge state and/or notify a user that one or more cooking elements are being disabled.

Operational sequence 220 begins in block 222 by monitoring the current battery level, e.g., by obtaining a current charge state of the battery from the battery manager circuit. One or more thresholds or criteria may be defined to determine when to selectively disable one or more loads (cooking elements) to maintain power consumption within the current capabilities of the rechargeable battery. For example, in the embodiment of FIG. 8, two threshold criteria are defined. The first threshold criterion defines a relatively lower threshold that, if the level of the battery falls below this threshold, two loads (cooking elements) will be disabled. The second threshold criterion defines a relatively higher threshold that, if the level of the battery falls below this threshold (but not below the first threshold), only one load (cooking element) will be disabled.

Block 224 therefore determines if the battery meets the first threshold criterion, e.g., by falling below the first threshold, and if so, passes control to block 226 to notify the user of the need to disable two loads, and then to block 228 to disable the two loads. It will be appreciated that disabling, in this context, may refer to deactivating an active cooking element in some situations, or in the case of cooking elements that are currently inactive, preventing those cooking elements from being activated in response to user activation of an associated user control. Cooking elements may be prioritized such that a lower priority cooking element will be disabled before a higher priority cooking element, and in some embodiments, activation of a higher priority cooking element may cause another active, but lower priority cooking element to be disabled. Notification is optional in some embodiments, but when employed, may utilize any of the notification manners discussed above.

Returning to block 224, if the first threshold criterion is not met, control passes to block 230 to determine if the second threshold criterion is met, e.g., by falling below the second threshold, and if so, passes control to block 232 to notify the user of the need to disable one load, and then to block 234 to disable the one load. Finally, returning to block 230, if the second threshold criterion is not met, control passes to block 236 to enable all loads. In addition, in the event that block 236 is reached as a result of the charge state of the battery increasing due to recharging, block 236 may also notify the user that the battery has been recharged and that additional load(s) are once again available for use. Upon completion of each of blocks 228, 234, and 236, control returns to block 222 to continue monitoring of the battery level.

Now turning to FIG. 9, an example implementation of an operational sequence for monitoring a weather forecast in a cooking appliance such as described above in connection with FIGS. 1, 2, and 4 above is illustrated at 240. Operational sequence 240 may be executed by a suitable control circuit or controller of a cooking appliance, e.g., controller 60 or control circuit 200, and may rely on weather information provided by an external device, e.g., a cloud service, a mobile device, etc. in communication with the cooking appliance. Operational sequence 240 may be used, for example, to predict the likelihood of a power loss (e.g., due to a thunderstorm, tornado, hurricane, etc.), and in response to predicting a potential power loss event, to conserve battery power in advance of the potential power loss event. While various manners of assessing a potential power loss event may be used in different embodiments, in some embodiments, detection of watches or warnings for the area in which the cooking appliance is installed may be used to predict a potential power loss, while in other embodiments, trained machine learning models may be used to detect potential power loss events based upon current and historical weather conditions. Other manners of predicting a power loss may be used in other embodiments, as will be appreciated by those of ordinary skill in the art having the benefit of the instant disclosure.

Operational sequence 240 begins in block 242 by monitoring the current weather forecast, e.g., by obtaining weather information from a remote weather service. Block 244 then determines whether a possible power loss is predicted, and if not, passes control to block 246 to enable all loads (cooking elements). If a potential power loss is predicted, however, block 244 passes control to block 248 to notify the user (e.g., in any of the manners discussed above) of the potential power loss, as well as the need to preserve the battery and the recommendation to disable use of the battery. In some embodiments, a user may be prompted to confirm or reject the recommendation, while in other embodiments, the recommendation may be automatically implemented. Control then passes to block 250 to disable the use of the battery and reject any attempts to activate multiple loads (cooking elements) or otherwise activate a combination of cooking elements that would require reliance on battery power to supply sufficient power to all activated cooking elements. Upon completion of either of block 246 or block 250, control returns to block 242 to continue to monitor the weather forecast.

In addition, in some embodiments, power sharing may be implemented externally from a cooking appliance, e.g., in a separate or retrofitted device coupled between an existing cooking appliance and an external power source. Power sharing may also be implemented separate from the main controller or control circuit of a cooking appliance in some embodiments.

It will be appreciated that, while certain features may be discussed herein in connection with certain embodiments and/or in connection with certain figures, unless expressly stated to the contrary, such features generally may be incorporated into any of the embodiments discussed and illustrated herein. Moreover, features that are disclosed as being combined in some embodiments may generally be implemented separately in other embodiments, and features that are disclosed as being implemented separately in some embodiments may be combined in other embodiments, so the fact that a particular feature is discussed in the context of one embodiment but not another should not be construed as an admission that those two embodiments are mutually exclusive of one another. Various additional modifications may be made to the illustrated embodiments consistent with the invention. Therefore, the invention lies in the claims hereinafter appended.

What is claimed is:

1. A cooking appliance, comprising:
first and second electric cooking elements;
first and second user controls respectively configured to operate the first and second electric cooking elements;
a line input configured to receive a power signal from an external power source;
a rechargeable battery; and
a control circuit coupled to the first and second electric cooking elements and the first and second user controls, the control circuit configured to, when the first electric cooking element is activated by the first user control, cause the first electric cooking element to be powered by the line input, and when the second electric cooking element is activated by the second user control, cause the second electric cooking element to be powered by the rechargeable battery instead of by the line input based upon whether the first electric cooking element is currently activated by the first user control.

2. The cooking appliance of claim 1, wherein the first electric cooking element is configured to be powered only using the line input, and the second electric cooking element is switchable between being powered only using the line input and being powered only using the rechargeable battery.

3. The cooking appliance of claim 2, wherein the control circuit includes first and second relays respectively coupling the second electric cooking element to the line input and the rechargeable battery, and the control circuit is configured to cause the second electric cooking element to be powered by the rechargeable battery instead of by the line input by activating the second relay while the first relay is deactivated.

4. The cooking appliance of claim 1, further comprising a third electric cooking element and a third user control configured to operate the third electric cooking element, wherein the control circuit is further configured to cause the second electric cooking element to be powered by the rechargeable battery instead of by the line input further based upon whether the third electric cooking element is currently activated by the third user control.

5. The cooking appliance of claim 4, wherein the first and second electric cooking elements are cooktop cooking elements and the third electric cooking element is an oven cooking element.

6. The cooking appliance of claim 4, wherein the control circuit is configured to cause each of the first, second, and third cooking elements to be powered by the line input when only one of the first, second, and third cooking elements is activated by the respective first, second, and third user control, cause the first cooking element to be powered by the line input and cause the second cooking element to be powered by the rechargeable battery when only the first and second cooking elements are activated by the respective first and second user controls, to cause the first cooking element to be powered by the line input and cause the third cooking element to be powered by the rechargeable battery when only the first and third cooking elements are activated by the respective first and third user controls, and to cause the first cooking element to be powered by the line input and cause the second and third cooking elements to be powered by the rechargeable battery when all of the first, second, and third cooking elements are activated by the respective first, second, and third user controls.

7. The cooking appliance of claim 1, wherein the control circuit is further configured to charge the rechargeable battery when the first and second electric cooking elements are deactivated by the respective first and second user controls.

8. The cooking appliance of claim 1, wherein the control circuit is further configured to detect a power loss and cause at least one of the first and second cooking elements to be powered by the rechargeable battery in response thereto.

9. The cooking appliance of claim 8, wherein the control circuit is further configured to determine a power loss threshold criterion based on a charge state of the rechargeable battery and to notify a user of limited power in response to detecting the power loss.

10. The cooking appliance of claim 9, wherein the control circuit is further configured to supply limited power to the first and second cooking elements based on the determined power loss threshold criterion.

11. The cooking appliance of claim 1, wherein the first and second electric cooking elements are among a plurality of electric cooking elements, and the control circuit is further configured to determine a power demand based upon an activation state of each of the plurality of cooking elements.

12. The cooking appliance of claim 11, wherein the control circuit is further configured to cause each activated electric cooking element among the plurality of electric cooking elements to be powered by the line input if the power demand meets a line threshold criterion.

13. The cooking appliance of claim 11, wherein the control circuit is further configured to determine a combined threshold criterion based on a charge state of the rechargeable battery.

14. The cooking appliance of claim 13, wherein the control circuit is further configured to notify a user of limited operation if the power demand meets the combined threshold criterion.

15. The cooking appliance of claim 13, wherein the control circuit is further configured to disable one or more of the plurality of electric cooking elements if the power demand meets the combined threshold criterion.

16. The cooking appliance of claim 1, wherein the first and second electric cooking elements are among a plurality of electric cooking elements, and wherein the control circuit is further configured to monitor a charge state of the rechargeable battery and to selectively disable one or more of the plurality of electric cooking elements based on the monitored charge state.

17. The cooking appliance of claim 16, wherein the control circuit is further configured to notify a user that the one or more of the plurality of electric cooking elements are being disabled.

18. The cooking appliance of claim 1, wherein the first and second electric cooking elements are among a plurality of electric cooking elements, and wherein the control circuit is further configured to monitor a weather forecast and to disable use of the rechargeable battery to power any of the plurality of electric cooking elements in advance of a predicted power loss based on the monitored weather forecast.

19. The cooking appliance of claim 18, wherein the control circuit is further configured to reject an attempt to concurrently use multiple electric cooking elements of the plurality of electric cooking elements in advance of the predicted power loss.

20. A method of operating a cooking appliance of a type including first and second electric cooking elements, first and second user controls respectively configured to operate the first and second electric cooking elements, a line input configured to receive a power signal from an external power source, and a rechargeable battery, the method comprising:
detecting user interaction with the second user control to activate the second electric cooking element;
in response detecting the user interaction, selecting between powering the second electric cooking element using the line input or powering the second electric cooking element using the rechargeable battery based upon whether the first electric cooking element is currently activated by the first user control; and
powering the second electric cooking element using the selected one of the line input and the rechargeable battery.
